(19) United States
(12) Patent Application Publication
(10) Pub. No.: US 2011/0254179 A1
(43) Pub. Date: Oct. 20, 2011

(54) Paddle Wheel Water Pusher

(76) Inventor: Kent Alan Henderson, Burlington, KS (US)

(21) Appl. No.: 12/762,339

(22) Filed: Apr. 18, 2010

(51) Int. Cl. B01F 3/04

(52) U.S. Cl. 261/92; 210/758; 261/120; 210/242.2

(57) ABSTRACT

The present invention uses paddle wheel to push water through a trough raising water above the level of surrounding water to the outlet of the trough from which the water flows across an outlet tray into a conduit protruding above surrounding water surface, containing the water falling from the outlet tray in the conduit as it travels to the outlet of the conduit.

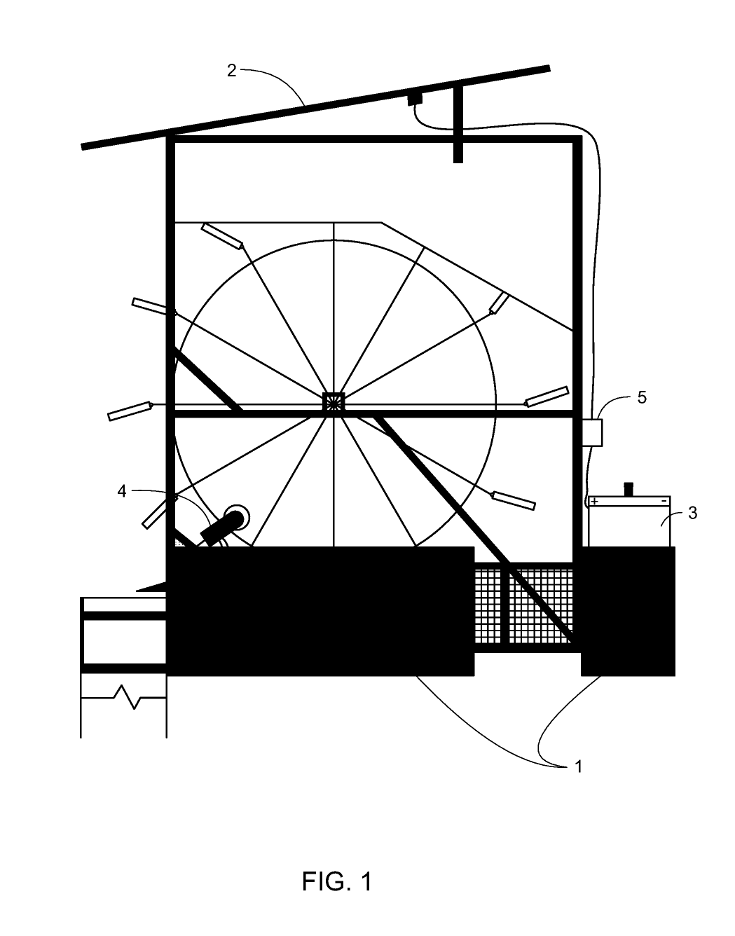

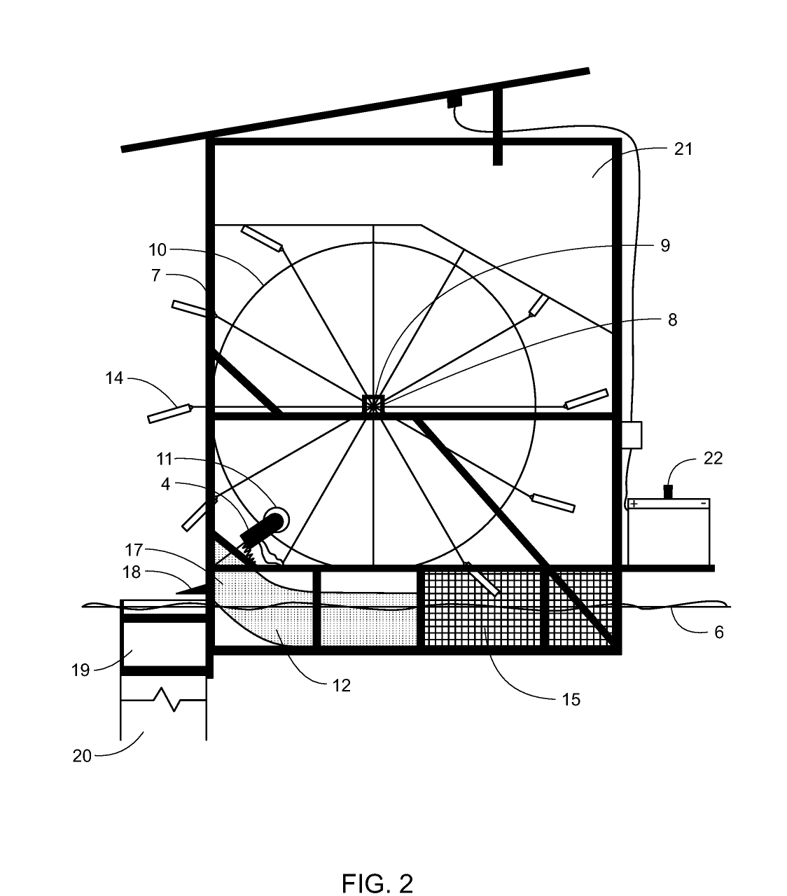

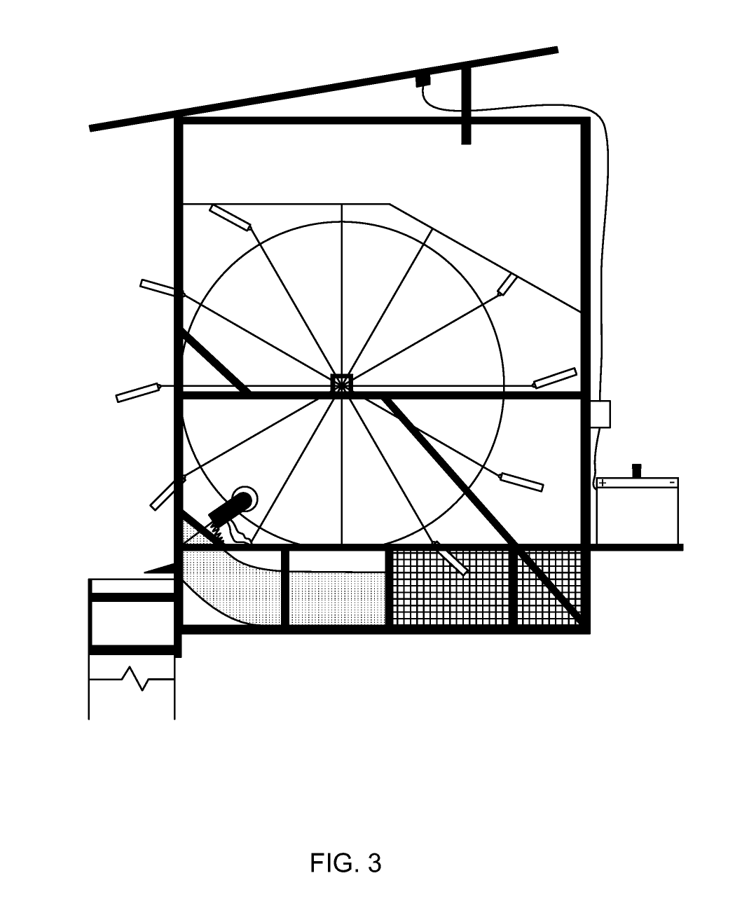

### CROSS-REFERENCE

Aeration Apparatus Patent #6,531,738 Category 261-92 February 1971

Pond Water Destratifier Patent #5,104,589 Category 261-120 March 1991

Method and Apparatus for Aerating Bodies of Water Patent #4,409,107 Category 210-758 October 1983

All of these patents are incorporated herein by reference; but none of these references is admitted to be prior art with respect to the present invention by its mention in the background.

### CROSS-REFERENCE TO RELATED APPLICATION(S)

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

It is well known that aerating and circulating water in bodies of water such as ponds and lakes is beneficial to the ecological system. Prior art uses paddle wheels to agitate the water allowing oxygen to be dissolved therein. Very little circulation is achieved in deeper water with these methods.

Also rotating the paddle wheel at enough revolutions per minute to agitate the water takes power, requiring a substantial power source such as a standard 110 volt power source.

### BRIEF SUMMARY OF THE INVENTION

The present invention uses a paddle wheel to push water through a trough raising water above the level of surrounding water to the outlet of the trough from which the water flows across an outlet tray into a conduit protruding above the surrounding water surface, containing the water falling from the outlet tray into the conduit as it travels to the outlet of the conduit.

These methods effectively aerate the water by contacting it with air as it is pushed from the trough and by containing the water in a conduit it effectively circulates the water to the conduit outlet which allows water to be forced to the lower levels of the pond or lake thus circulating the water.

By turning the paddle wheel at a low rate of revolution per minute the power usage is greatly reduced when compared to prior art. This low rate of power usage makes solar power an option. The low rate of power usage also makes battery operation with solar charging possible.

### BRIEF DESCRIPTION OF DRAWINGS

Page 1 of the drawings illustrates the invention supported by floats.

Page 2 of the drawings shows the preferred embodiment of the invention with the floats not shown in the drawing.

Page 3 of the drawings is a representative drawing with the floats not shown in the drawing.

### DETAILED DESCRIPTION OF THE INVENTION

Page 1 of the drawings shows the preferred embodiment of the invention that includes it being mounted on floats (1) to support it on the surface of the water and the use of a solar panel (2) to collect energy to charge the battery (3) to transmit power to the electric drive motor (4). A charge control unit (5) is used to regulate the electrical flow.

Page 2 shows the invention partially submerged in the water (6). To the frame (7) are mounted bearings (8) that support an axle (9) The paddle wheel (10) rotates on the axle (9) powered by an electric motor (4) to turn it using a mechanical drive (11). A trough (12) in the bottom of the frame has dimensions being a close fit for paddles to travel through causing the water in the trough to be pushed ahead of the paddles (14).

The porous trough on the intake side (15) allows water into and stops objects from entering the trough. The nonporous trough (12) follows the radius of the outside of the paddle wheel (10) from below the paddle wheel (10) around and up one side ending (17) above surrounding water level (6). The water flowing from the end of the non porous trough (13) exits the trough then flows over an outlet tray (18).

An open end of a conduit (19) is placed above water level under the end of the outlet tray (18) to catch the water pushed through the trough (12) by the paddle wheel (10). The water then travels through the conduit (19) to the outlet of the conduit (20).

Sheeting (21) on the topside of the frame (7) to shield the paddles from wind gusts.

A switch (22) is used to turn the power to the paddle wheel on or off.

### DESCRIPTION OF THE PRESENT INVENTION IN USE

Power is acquired through a solar panel (2) then used or stored in the battery (3) controlled by the charge control unit (5) that sends power to a switch that when on powers an electric motor (4) that rotates the paddle wheel (10) through mechanical linkage (12) rotating the paddle wheel (10) to push water through the trough (12) to raise the water above the level of surrounding water(6). As the water leaves the nonporous trough (12) it contacts with air aerating it as it flows across the outlet tray (18) and falls downward to be confined inside the conduit (19).

The water travels through the conduit (19) to the conduit outlet (20) circulating the water.

It will be apparent to those skilled in the art that the particular shapes, dimensions, and other details of construction of the paddle wheel water pusher assembly and its component parts could be further modified in various ways within the principles of the present invention. The present specification, however, sets forth some of the ways in which the invention may be put into practice, including the best mode presently contemplated for carrying out the invention.

The invention size may be modified to enhance effectiveness on different sized water bodies.

Different power options my be used to power the invention.

What is claimed is:

1. method to aerate and circulate water using a paddle wheel to push water in a trough to raise the water above the surrounding water.

2. method to circulate water using a conduit that collects the water from the paddle wheel and controls where the water is released back into the surrounding water.
